(19) United States
(12) Patent Application Publication
(10) Pub. No.: US 2020/0088560 A1
(43) Pub. Date: Mar. 19, 2020

(54) LEVEL SENSING FOR DISPENSER CANISTERS

(71) Applicant: Fluid Management Operations LLC, Wheeling, IL (US)

(72) Inventors: Jacek Pieczaba, Wheeling, IL (US); Joe Gardner, Elk Grove Village, IL (US)

(73) Assignee: Fluid Management Operations LLC, Wheeling, IL (US)

(21) Appl. No.: 16/575,794

(22) Filed: Sep. 19, 2019

Related U.S. Application Data
(60) Provisional application No. 62/733,337, filed on Sep. 19, 2018.
(60) Provisional application No. 62/797,764, filed on Jan. 28, 2019.
(60) Provisional application No. 62/843,700, filed on May 6, 2019.

(51) Int. Cl. G01F 23/18

(52) U.S. Cl. CPC G01F 23/18

(57) ABSTRACT

A system for detecting the level of a fluid in a dispensing container may comprise a pressure sensor comprising a detection end disposed inside a dispensing canister. The dispensing canister may have a top and a bottom that is configured to dispense a fluid. The pressure sensor may be operably attached to the canister. The system may further comprise a processing unit comprising a motor control board and a control circuit comprising a processor and programming resident in memory to determine the level at which the fluid is present.

This application claims priority to the following applications: U.S. Ser. No. 62/733,337, entitled LEVEL SENSING FOR DISPENSER CANISTERS, filed Sep. 19, 2018, which is incorporated herein by reference, U.S. Ser. No. 62/797,764, entitled METHOD TO MEASURE LEVEL OF COLORANT IN CANISTER, filed Jan. 28, 2019, which is incorporated herein by reference, and U.S. Ser. No. 62/843,700, entitled LEVEL SENSING FOR DISPENSER CANISTERS, filed May 6, 2019, which is incorporated herein by reference.

### BACKGROUND

Dispenser canisters are used in retail paint tinting equipment to dispense colorant into a paint tinting process. Colorant is dispensed to provide a desired paint color by utilizing specific combinations of colorant. The volume of colorant in the dispenser canisters can be monitored so that the canisters do not become empty during a paint tinting process. An empty canister during a paint tinting process may result in paint that is tinted to the wrong color, lost profits, poor results, wasted product, disposal costs, customer dissatisfaction, or service calls. Various level sensing technologies are used in the paint tinting industry to monitor colorant canister levels, but often the accuracy is compromised by colorant and canister properties that interfere with sensor technology (e.g. colorant viscosity, canister coating, etc.). Accurate level sensing can help to have paint that is tinted to the correct color.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for sensing a level of a material disposed in a dispensing canister to provide a desired volume of the material in the canister. For example, the level sensing system may be used to determine that there is a sufficient volume of colorant in a dispensing canister in order to perform a paint tinting or hair dye tinting process. Having a sufficient volume of colorant helps to mitigate air entering the pump, tubing, and nozzles of the tinting machine. Further it helps mitigate incorrectly tinted product, wasted product, wasted colorant, and disposal issues associated with a less than desired tinting process.

In one implementation, one or more metallic probes may be used to detect the level of colorant inside a dispensing canister. In this example, the metallic probes can be located at a predetermined position in the dispensing canister to detect whether the colorant is above or below the metallic probes within dispensing canister. Further, in this implementation, electrical signals can be generated and transmitted through the metallic probes, and the resultant signals can be measured in accordance with the transmitted signals. The resultant signals may vary depending on the material in which the metallic probes are immersed. Different colorants may also have different properties (e.g. capacitance, permittivity, conductance, moving charged particles, etc.), and the resultant signals may be different for different colorants, and/or for air in the dispensing canister. The values of the measured signals may be compared to predetermined values to identify whether the metallic probes are immersed in colorant, or are surrounded by air.

In another embodiment, one or more thermistors may be used to detect the level of the colorant inside a dispensing canister. In this example, the thermistors can be located at a predetermined position in the dispensing canister to detect whether the level of the colorant is above or below the portion of the thermistor that is disposed within the dispensing canister. Further, in this implementation, electrical current can be generated and passed through a thermistor, which generates heat. Resistance can be measured from the thermistor to identify the rate of heat dissipation. Heat dissipation may be different depending on the material in which the thermistor(s) are immersed. Therefore, the resultant resistance and the level of heat dissipation may vary for different colorants, and for air inside of the dispensing canister. The change in resistance can correlate to a change in heat dissipation, and these values may be compared to predetermined values to identify whether the thermistor(s) are immersed in colorant, or are surrounded by air.

In another embodiment, one or more pressure sensors may be used to detect the level of a material, such as a colorant, inside a dispensing canister. In this example, a pressure sensor can be located on the bottom of the dispensing canister to detect the level of the product. The pressure sensor on the bottom of the dispensing canister can be a water-proof pressure sensor. Further, in this implementation, an ambient pressure sensor can also be used to measure the ambient atmospheric pressure. The ambient pressure sensor can be an air sensor. In this example, the system can be calibrated by taking initial pressure measurements with an empty dispensing container and subsequent pressure measurements with a filled dispensing canister. The calibrated system can determine the level of the colorant inside the dispensing canister in a continuous manner.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a component diagram illustrating one implementation of an example system that utilizes a metallic probe for level sensing.

FIG. 2 is a cross sectional component diagram illustrating one or more portions of one or more systems described herein.

FIG. 3 is a component diagram illustrating one or more portions of one or more systems described herein.

FIG. 4 is a cross sectional component diagram illustrating one or more portions of one or more systems described herein.

FIG. 5 is schematic diagram illustrating one implementation of an example electrical circuit of a level sensing system utilizing a metallic probe.

FIG. 6 is a component diagram illustrating one or more portions of one or more systems described herein.

FIG. 7 is a component diagram illustrating one or more portions of one or more systems described herein.

FIG. 8 is a component diagram illustrating one or more portions of one or more systems described herein.

FIG. 9 is a component illustration of one implementation of an example waveform-generating device showing an example waveform for a metallic probe not immersed in colorant.

FIG. 10 is a component illustration of the waveform-generating device showing an example waveform for a metallic probe immersed in colorant.

FIG. 11 is a component illustration of the waveform-generating device showing an example waveform for a metallic probe coated but not immersed in colorant.

FIG. 12 is a component diagram illustrating one or more portions of one or more systems described herein.

FIG. 13 is a component diagram illustrating one or more portions of one or more systems described herein.

FIG. 14 is a component diagram illustrating one implementation of an example thermistor level sensing system.

FIG. 15 is a component diagram illustrating one or more portions of one or more systems described herein.

FIG. 16 is a component diagram illustrating one or more portions of one or more systems described herein.

FIG. 17 is a schematic diagram illustrating one implementation of an example electrical circuit for the level sensing system utilizing a thermistor.

FIG. 18 is an example diagram indicating a waveform for the level sensing system.

FIG. 19 is an example display indicating a change in resistance value less than a pre-determined threshold.

FIG. 20 is an example display indicating a change in resistance value greater than a pre-determined threshold.

FIG. 21 is block diagram illustrating one implementation of an example pressure level sensing system.

FIG. 22 is a component diagram illustrating one implementation of an example pressure level sensing system.

FIG. 23 is a cross-section of a component diagram illustrating one implementation of an example pressure level sensing system.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Level Sensing via Metallic Probe

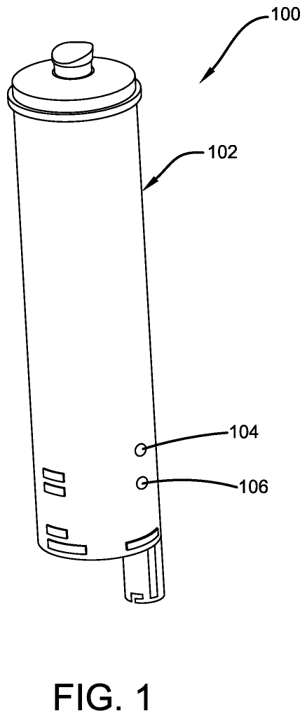

FIG. 1 is a component diagram illustrating one implementation of an example, system 100 for detecting a level of colorant in a colorant dispensing container. In this implementation, a dispenser canister 102 may be used in a paint tinting machine to store colorant used to tint paint. The dispenser canister 102 may be equipped with the level sensing system 100 to detect the presence of colorant in the dispensing canister 102 at the location of a sensor 104, for example, to identify whether a desired amount of colorant is present in the canister 102 to perform a desired task (e.g., tinting a paint). In this implementation, the level sensor may be engaged with the dispensing canister at a desired location on the dispensing canister (e.g., at a location indicating a low level 104 of colorant within the dispensing canister, etc.). As one example, the level of the colorant may be used, and combined with the known dimensions of the dispensing canister, to determine the volume of colorant remaining in the dispensing canister.

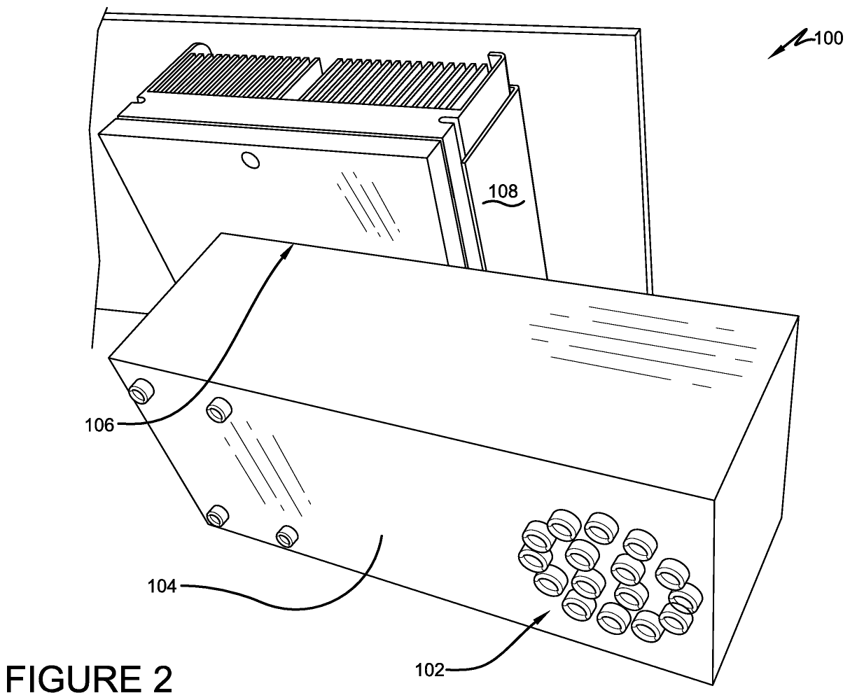

With continued reference to FIG. 1, FIGS. 2-13 illustrate one or more portions of an example implementation of a system (e.g., 100) for level sensing using metallic probes 904. In one implementation, the level sensing system 100, 300 can comprise one or more metallic probes 904 engaged with the dispensing canister 102, an electronic circuit 500, and level sensing software (not shown). The metallic probe 904 may comprise two or more electrodes 504, 506 electrically coupled with the circuit 500, that are configured to make physical contact with the colorant (e.g., when present) within the dispensing canister.

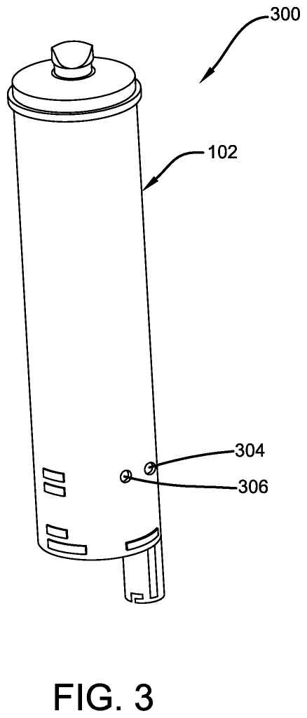

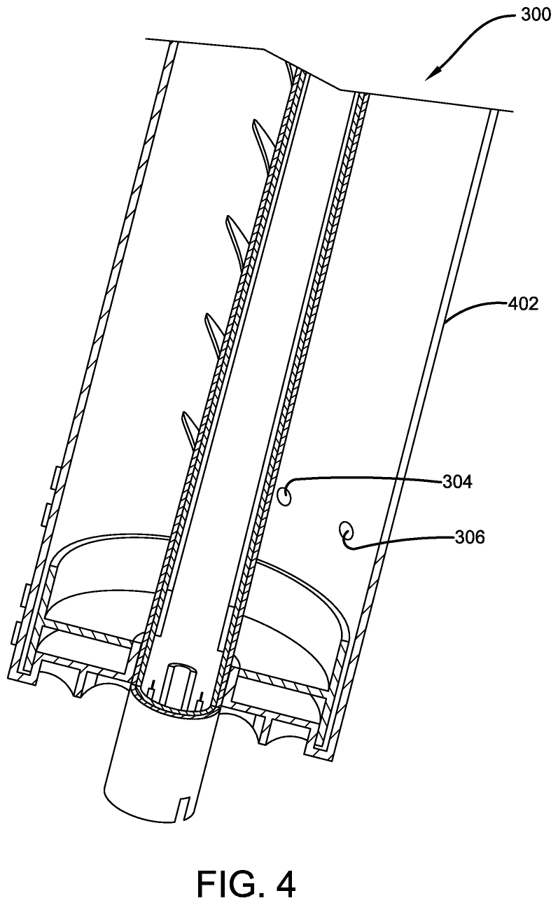

The metallic probes 904 may be engaged with the container 102 in any desired orientation relative to the dispensing canister 102. For example, the electrodes 504, 506 can be oriented in a vertical position, horizontal position, or any position in between horizontal and vertical relative to the position of the canister 102. As an illustrative example, FIGS. 1 and 2 illustrate an example level sensing system 100 that comprises vertically oriented metallic probes; and FIGS. 3 and 4 illustrate an example level sensing system 300 that comprises horizontally oriented metallic probes.

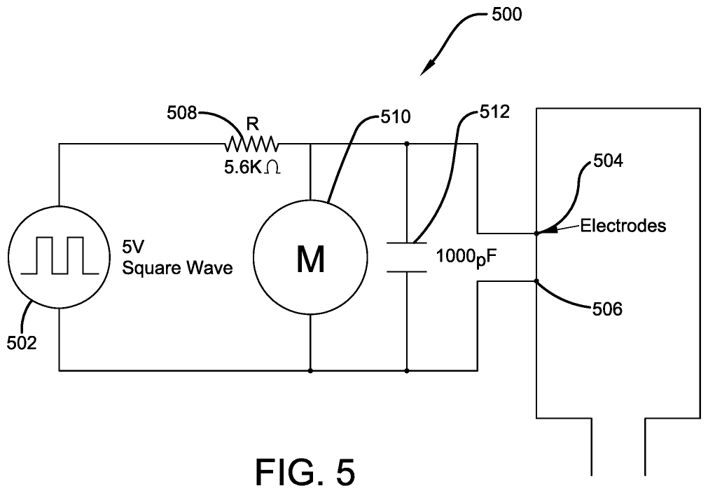

FIG. 5 is a schematic diagram illustrating an example electrical circuit 500 that may comprise a waveform-generating device 502, a resistor 508, a waveform-measuring device 510, a capacitor 512, any number of electrodes 504, 506, and other components used in such a system. In one implementation, the waveform-generating device 502 may be utilized to generate electronic signals in alternating current (AC) or direct current (DC) to be sent to the electrodes 504, 506. As an example, the waveform-generating device 502 may adjust various aspects of the electronic signal (e.g., frequency, amplitude, voltage, current, waveform, etc.). Further, the waveform-measuring device 510 may measure the resultant electronic signal between the electrodes 504, 506 of a metallic probe 904 resulting from the electronic signal produced by the waveform-generating device 502. Additionally, in this example, the waveform-measuring device 510 may detect current, voltage, phase lag, waveform shape, impedance, etc. In one implementation, the resultant electronic signal may be compared to the generated electronic signal or compared to predetermined values to identify whether the metallic probe(s) 904 are immersed in colorant 1010, coated in colorant 1010 but not immersed, or are surrounded by air.

In one implementation, the resultant voltage between the metallic probes 504, 506 may be compared to a predetermined threshold to identify whether the metallic probe is immersed in colorant or surrounded by air. For example, the voltage differential across metallic probe 504 and metallic probe 506 may vary based on the material in which the probes are immersed, which may provide for different thresholds for different materials.

It can be appreciated that the electronic circuit 500, shown in FIG. 5, may be modified for various different fluids or embodiments (e.g., different colorant, size of dispensing canister 102, distance between electrode 504 and electrode 506, etc.). By way of example, the resistor 508 may be a 5K ohm resistor that may give greater contrast between the resultant signals (e.g., contrast between metallic probes immersed in colorant compared to metallic probes not immersed in colorant). For example, a greater contrast may provide for improved detection time and more accurate detection. Further, a capacitor 512, such as a 1000 pF capacitor, may be used to limit high frequency noise during testing.

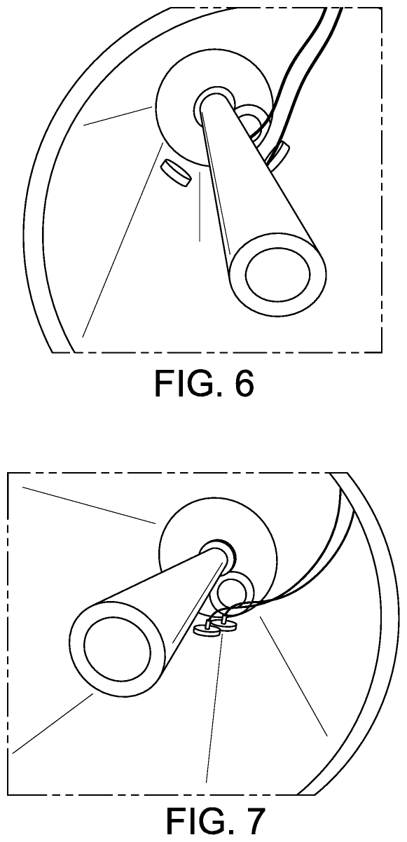

FIGS. 6 and 7 illustrate an internal view of the canister 102 showing the metallic probe 904 engaged with canister 102. The metallic probe 904 may engage the canister 102 at a location 104 which may allow the metallic probe to come into thermal contact with colorant 1010.

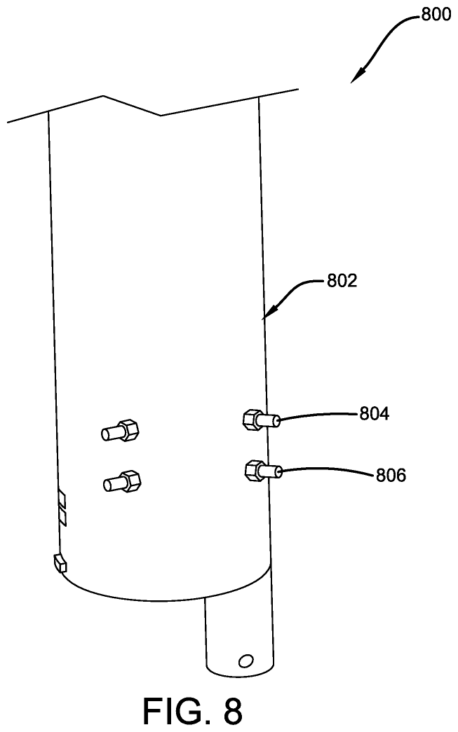

In one implementation, one or more metallic probes 904 may be engaged with the canister 102 in a variety of configurations (e.g., two or more sets of probes at the same level, vertically, on the dispensing canister 802, two or more sets of probes disposed at different levels, vertically, on the dispensing canister, etc.). FIG. 8 illustrates an example level sensing system 800, comprising two or more metallic probes 804, 806 disposed substantially at the same level, vertically, on the dispensing canister 802. For example, this configuration may provide for redundancy if one set of probes fails to operate. Further, a level sensing system (e.g., 800) comprising two or more metallic probes disposed at different vertical levels on the dispensing canister may provide for multiple level indications, which can provide for improved precision (e.g., a system of two metallic probes may provide indication showing a level between a first metallic probe and a second metallic probe).

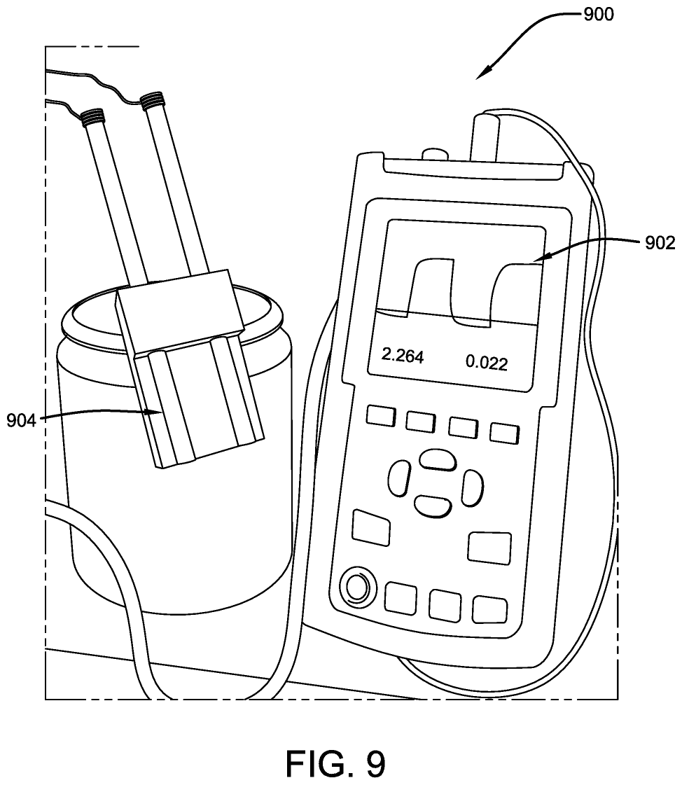

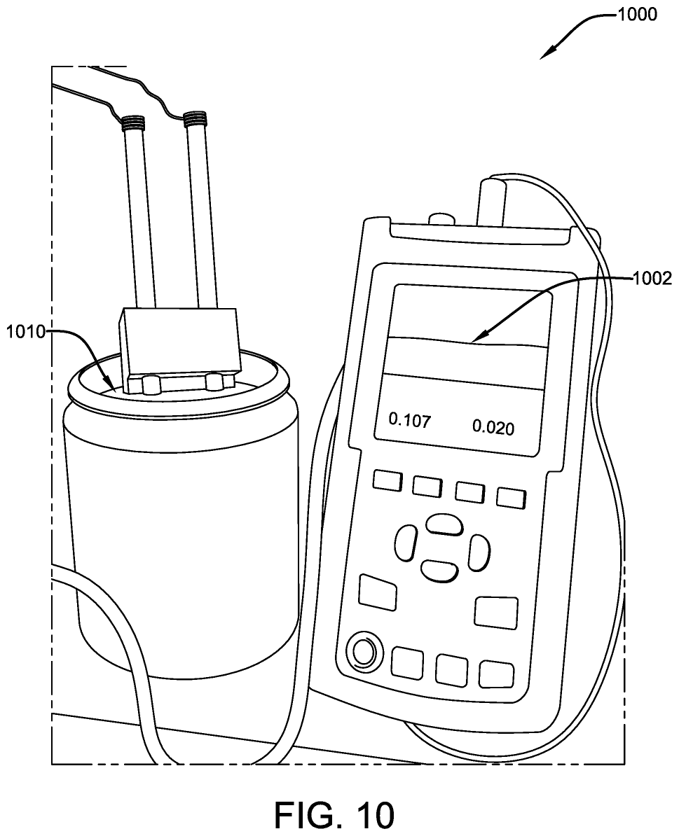

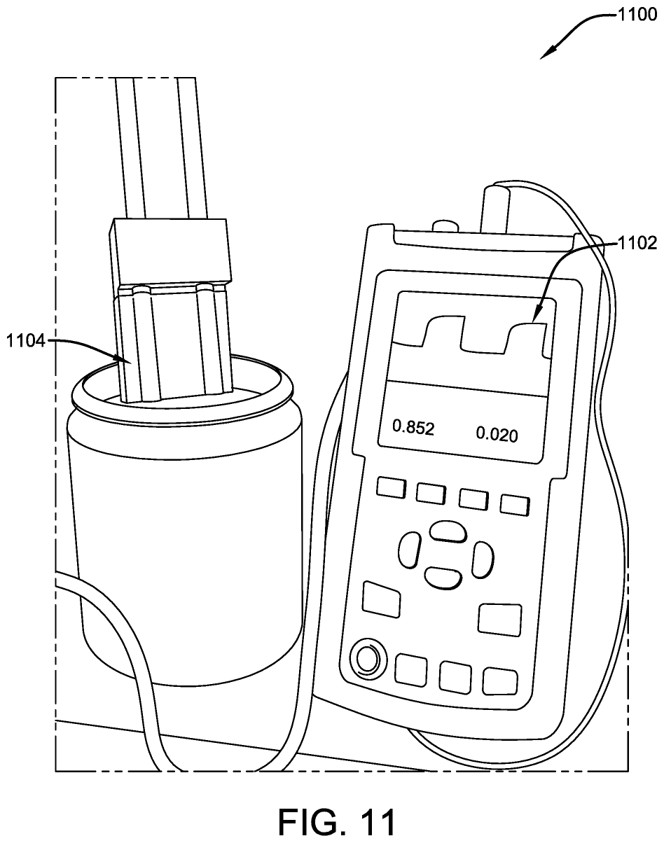

FIGS. 9-11 illustrate example electronic signals that may be captured by the waveform-measuring device 510. As an example, visual inspection of electronic signals may help identify whether the metallic probe 904 is immersed in colorant 1010 or surrounded by air. FIG. 9 illustrates an example waveform 902 for a metallic probe 904 that is not immersed or coated in colorant. FIG. 10 shows an example waveform 1002 for a metallic probe 904 that is immersed in colorant 1010. FIG. 11 shows an example waveform 1102 for a metallic probe 1104 that is coated in colorant 1010, but not fully immersed. By example, immersed metallic probes 904 may create electronic signals with lower amplitudes compared to the metallic probes 904 that are not immersed. In this example, visual comparison of the electronic signals may help to identify whether the metallic probe(s) 904 are immersed in colorant 1010, coated in colorant 1010 but not immersed, or are surrounded by air.

In another implementation, the electronic signals can be monitored by a signal reader system, which, combined with system programming and a processing unit, may be able to identify whether the metallic probes 904 are immersed in colorant 1010, which can mitigate visual inspection of the electronic signals. The programming in combination with the processor may be able to analyze the electronic signal to identify and track the effects of various situations, such as colorant thickening, product buildup on the probes, or other colorant conditions at the metallic probes 904 or the canister wall 202. As an example, the programming may utilize at least one of the signal values measured from the waveform-measuring device 510 for the further analysis. Further, for example, the programming can comprise different thresholds and configurations respectively associated with different canisters and/or colorants. For example, respective canisters 102 may have their own individual threshold and configuration to help provide accurate readings from the metallic probes 904.

By example, in one implementation, a microprocessor may be used as the waveform-generator 502 to generate different waveforms (e.g., excitation voltages, frequencies, etc.). In this implementation, a digital-to-analog converter (DAC) may be used along with the microprocessor to provide waveforms to the electrical circuit 500. As one example, multiple measurements from the waveform-measuring device 510 may be identified over shorter intervals, and used along with digital filtering, to help mitigate electromagnetic noise, which can help improve accuracy and performance.

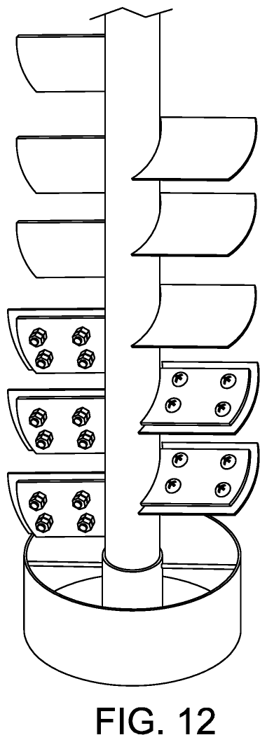

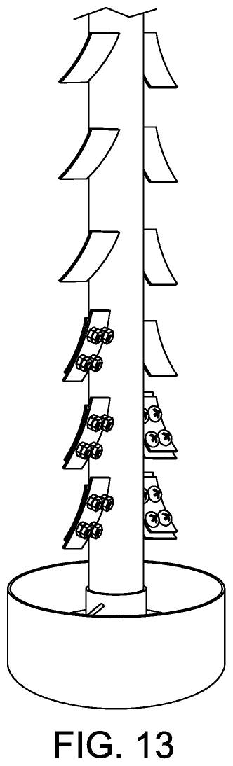

FIGS. 12 and 13 are component diagrams that illustrate an example embodiment of the level sensing system 100, 300. For example, interference from excess or dried colorant deposited on a sensor can affect existing level sensing technology. In one implementation, the metallic probes 904 described herein may improve level sensing technology by helping to mitigate interference from excess or dried colorant. However, in some circumstances, excess or dried colorant may be at least partially removed from the sensors, and/or internal walls of the dispensing canister. In one implementation of the level sensing system 100, 300, as shown in FIGS. 12 and 13, scraper blades or wiper blades may be used to clean the electrodes 504, 506 of excess or dried colorant, which may help to mitigate interference.

Level Sensing via Thermistor

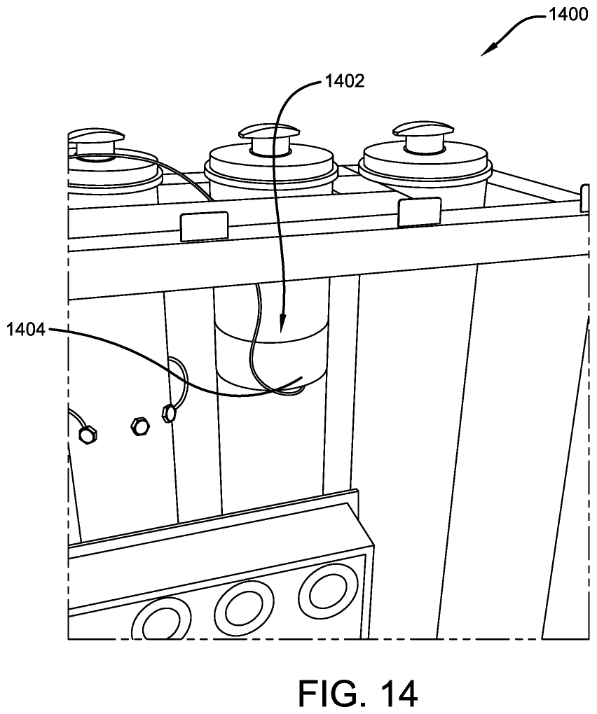

With continued reference to FIG. 1, FIGS. 14-20 illustrate one or more portions of an example implementation of a system (e.g., 1400) for level sensing using a thermistor 1510. FIG. 14 illustrates one implementation of the level sensing system 1400 which may comprise one or more thermistors 1510 engaged with the dispensing canister 1402 at location 1404. Further, a level sensing system comprising a thermistor 1510 can comprise an electronic circuit 1700, and level sensing programming (not shown). In one implementation, the thermistor 1510 can be electrically coupled with the circuit 1700, and configured to make physical contact with the colorant 1010 (e.g., when present) within the dispensing canister 1402. Thermistors may be attached to a dispensing canister 102 through a via from the outside to the inside of the canister 1402 wall. In one implementation, the thermistor 1510 can be fixedly engaged in the wall using any appropriate means, including, but not limited to an adhesive, friction fit, welded, fastened, etc. Further the thermistor 1510 can be thermally isolated from other solid objects (e.g., using insulation).

In one implementation, two or more thermistors 1510 may be engaged with the canister 1402 in a variety of configurations (e.g., at the same vertical level on the dispensing canister 1402 wall, at different vertical levels on the dispensing canister 1402 wall, etc.). For example, a level sensing system 1400, comprising two or more thermistors 1510 at the same vertical level on the dispensing canister 1402 wall may provide redundancy if one thermistor fails to operate. Further, a level sensing system 1400 comprising two or more thermistors 1510 at different vertical levels on the dispensing canister 1402 wall may provide multiple level indications to provide greater precision in identifying the volume of the liquid in the canister (e.g., a system of two thermistors 1510 may provide indication showing a level between a first thermistor and a second thermistor).

In one implementation, a thermistor may be used to detect whether the colorant 1010 is in contact with the thermistor 1510 that is disposed within the dispensing canister 1402. In this way, for example, the thermistor 1510 can be used to determine if the colorant level is above or below the level of the thermistor 1510. As one example, a thermistor 1510 can generate heat when a current is applied to the thermistor. In this example, when current is removed from the thermistor 1510, the heat may dissipate at a rate dependent on the material surrounding the thermistor 1510. Therefore, in this example, the heat dissipation will be different when colorant is preset at the thermistor that when merely air is present at the thermistor. In one implementation, the system 1400 may incorporate one or more thermistors 1510 that can detect a change in temperature over time. As one example, different materials may have different specific heats (e.g., water based colorants may have a higher specific heat than air, etc.). Thus, in this example, the change in temperature over time may differ for materials with different specific heats. In this implementation, the level sensing system 1400 may detect a change in specific heat that may indicate a change in material in thermal contact with the thermistor 1510. Further, in this implementation, the change in temperature may be compared to a predetermined temperature threshold which can help detect whether the level of the colorant is above or below the portion of the thermistor 1510 that is disposed within the dispensing canister 1402.

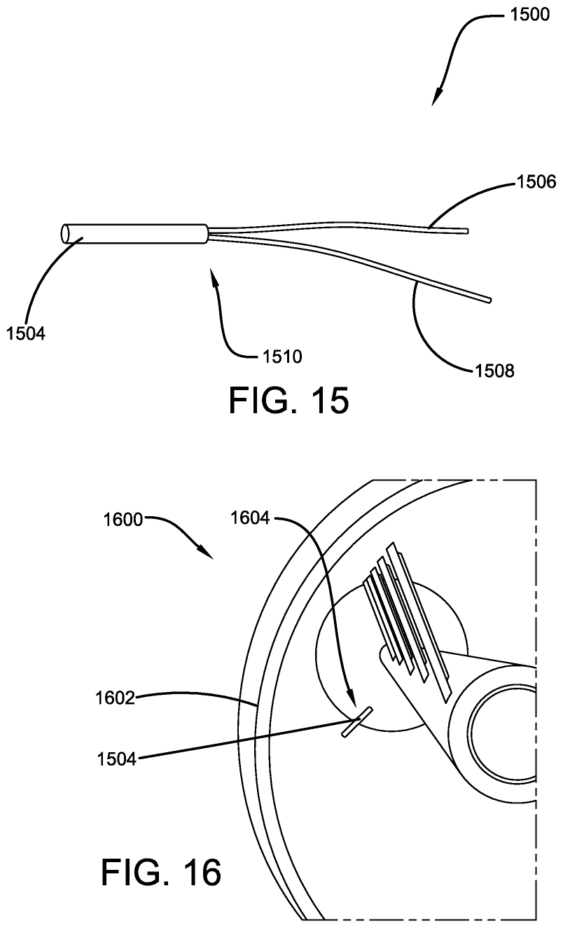

FIG. 15 is an illustration of one implementation of a thermistor 1510 showing the thermistor probe 1504 and the thermistor electrical connections 1506, 1508. FIG. 16 is an illustration of one implementation of an internal view of the dispensing canister 1402 illustrating the thermistor probe 1504 extending through the dispensing canister wall 1602. In one implementation, the thermistor probe 1504 may be configured to make thermal and physical contact with the colorant 1010 (e.g., when present) within the canister 1402 at location 1604.

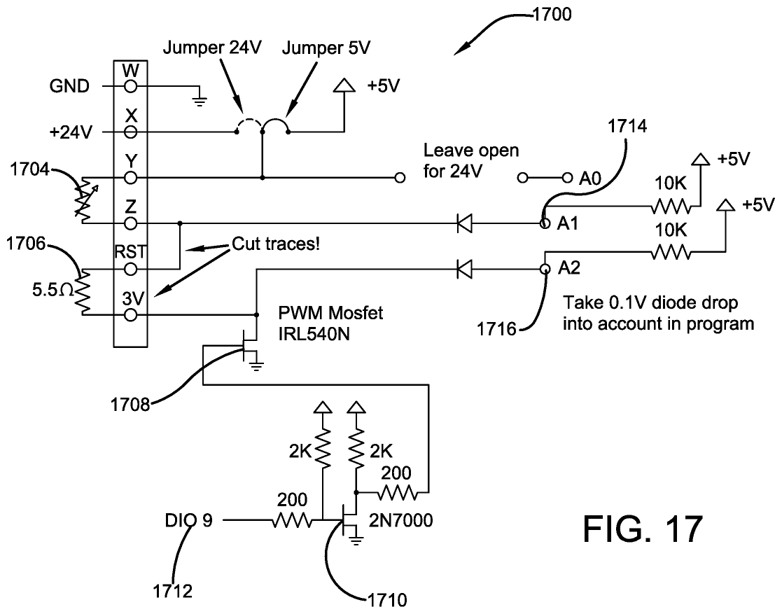

FIG. 17 illustrates a schematic of an example electronic circuit 1700, which may be used in the level sensing system described herein. In one implementation, the electronic circuit 1700 may comprise a thermistor 1510, a current sensing resistor 1706, a metal-oxide-semiconductor field-effect transistor 1708 (MOSFET), a programmable micro-controller (not shown) and other components used in such a system. In this implementation, the thermistor 1704 and the current sensing resister 1706 may be in series configuration as illustrated in the circuit 1700. As one example, electronic current may be controlled using the MOSFET 1708 and the micro-controller, and may be able to achieve a desired pulse-width modulation (PWM). In this example, the micro-controller can feed an input 1712 to a MOSFET 1710 to control the PWM by the MOSFET 1708. Further, this example, the micro-controller may monitor the thermistor 1510 resistance by measuring the voltage drop across the current sensing resistor (e.g., at location 1714 and location 1716) and applying Ohm's law, etc. For example, the thermistor 1510 resistance may be monitored over a period of time, and may be used to detect a change in temperature, which may be used to detect a change in specific heat. As an example, a high change in resistance may be indicative of a high change in temperature, which may be indicative of a lower specific heat. In this example, the change in specific heat may help detect a change in material that is in thermal contact with the thermistor probe 1504 (e.g., a steady state specific heat that transitions to a lower steady state specific heat may indicate a transition from colorant 1010 to air, etc.). In one implementation, this state change, indicative of a change in material present, may be used to detect whether the level of the colorant 1010 is above or below the portion of the thermistor probe 1504 that is disposed within the dispensing canister 1402 (i.e., may detect low level of colorant 1010 in the dispenser canister 1402).

In one implementation, the level sensing system 1400 may operate by applying a constant duty cycle at a constant voltage through the thermistor 1510 (e.g., a voltage may be applied with a 1/1 duty cycle that may produce a constant signal). In this implementation, the resistance of the thermistor may be calculated by measuring various properties of the electronic circuit 1700 (e.g., current, voltage, etc.) while applying current through the thermistor 1510. For example, a change in thermistor 1510 resistance may be used to detect a change in temperature or a change in specific heat, which may be indicative of a change in the material in thermal contact with the thermistor probe 1504. In this implementation, this change in state, indicative of a change in material present at the thermistor 1510, may indicate whether the level of the colorant 1010 is above or below the portion of the thermistor probe 1504 that is disposed within the dispensing canister 1402. Further, for example, the resistance at the thermistor 1510 may remain constant (i.e., steady state) while immersed in colorant 1010. In this example, a change in resistance following a period of steady state resistance may be indicative of the colorant 1010 level falling below the thermistor probe 1504, and may indicate a level of colorant 1010 (e.g., low level, empty level, etc.).

In another implementation, the level sensing system 1400 may operate by achieving a constant thermistor 1510 resistance, which may be achieved by controlling the duty cycle of the current through the thermistor 1510. For example, the duty cycle is a representation of the pulse width per signal period (e.g., a signal with a duty cycle of 4/5 may represent a signal that is “on” for 4/5 of the time). In this implementation, by controlling the duty cycle, the level sensing system 1400 may be able to keep the thermistor 1510 resistance substantially constant if a change in material causes a change temperature, specific heat, etc. In one implementation, the duty cycle can be monitored to identify characteristics (e.g., heat dissipation, specific heat, probe temperature, etc.) of the material surrounding the thermistor probe 1504. In this implementation, a predetermined threshold for the duty cycle may be set (e.g., using duty cycles of known materials) to indicate if the thermistor probe 1504 is no longer immersed in the colorant 1010. As one example, the predetermined threshold may be adjusted accordingly to account for a different colorant, which may help mitigate inaccurate measurements.

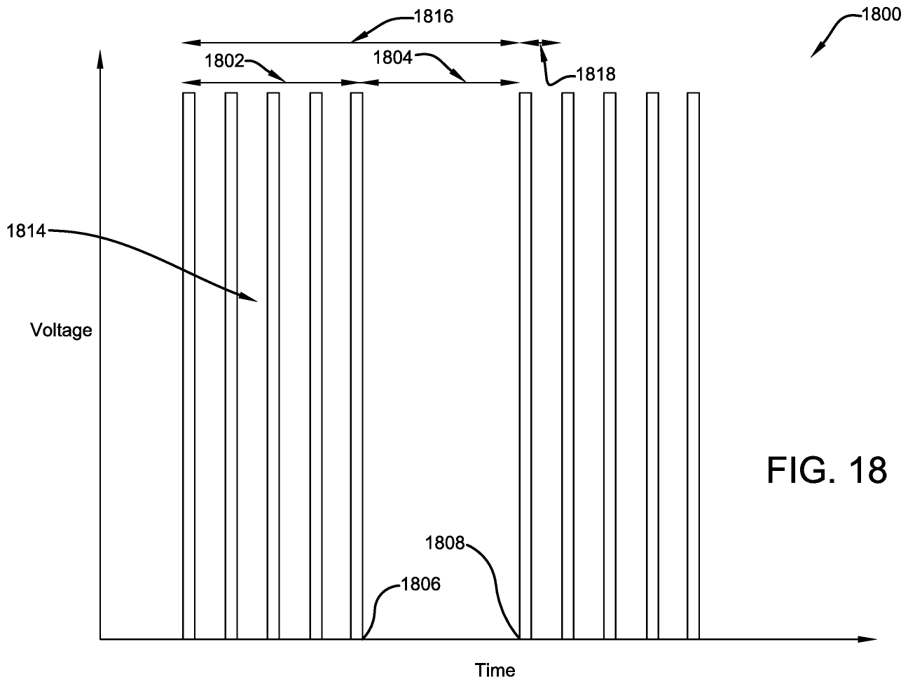

In another implementation of the level sensing system 1400, current can be applied through the thermistor 1510 using PWM at a fixed duty cycle. FIG. 18 illustrates an example waveform that may be generated by the electrical circuit 1700. In this example, the duty cycle represented by signal period 1816 may operate at a fixed “on” time 1802 and a fixed “off” time 1804. Further, the pulse-width modulated signal 1814 may be generated during the ‘on” time 1802, and no signal may be generated during the “off time” 1804. In one implementation, the pulse-width modulated signal 1814 may be generated via a programmable microcontroller and the MOSFET 1708. In this implementation, the fixed duty cycle may operate such that the “on” time may remain consistent throughout, and the “off” time may remain consistent throughout the cycle. The duty cycle for signal period 1818 for the pulse-width modulated signal 1814 may be a different duty cycle than the duty cycle for signal period 1816.

In another implementation, the resistance of the thermistor 1510 may be identified at two different times 1806, 1808 during the signal period 1816. For example, the resistance may be determined immediately following the “on” period at time 1806 of the signal, and immediately following the “off” period at time 1808 of the signal. In this example, a change in temperature may be calculated using the change in resistance values between a first time 1806 and a second time 1808 of the signal. For example, the change in temperature may be used to determine a change in heat dissipation or specific heat. The change in heat dissipation or specific heat may be indicative of the thermistor probe 1504 no longer being immersed in colorant 1010.

Further, one implementation, a predetermined threshold may be set for a change in resistance that be indicative of a change in colorant level (e.g., if a change in resistance is calculated and is beyond the threshold, a low level of colorant may be determined, etc.). In this implementation, the change in resistance may be indicative of a change in material surrounding the thermistor probes 1504. For example, the predetermined threshold may be set using resistance values of known materials (e.g., colorant, air, etc.), and may be configured accordingly. Individual threshold values may be configured for different colorants or materials.

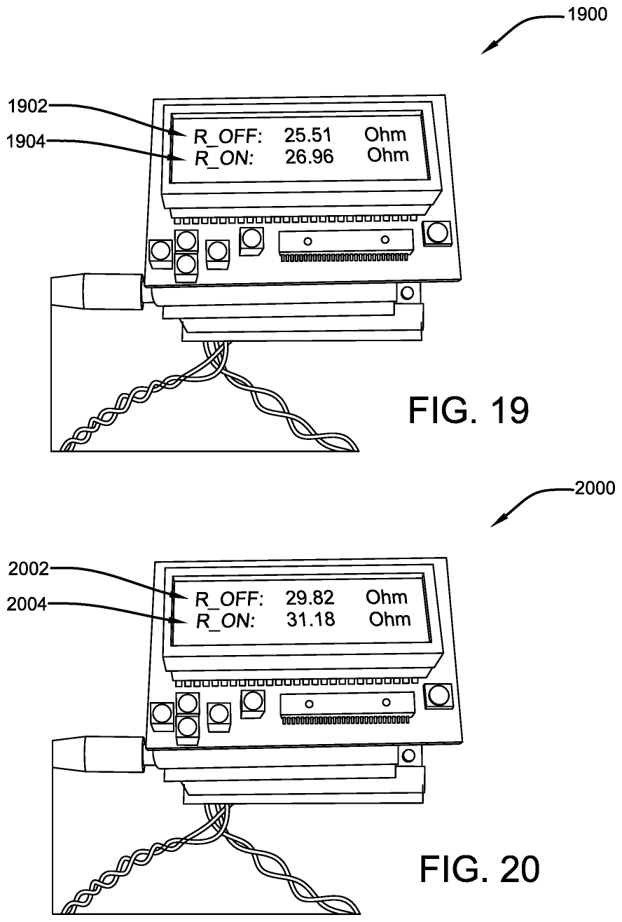

FIGS. 19 and 20 illustrate an electronic display that may be used to indicate resistance values. In one implementation, the electronic display (e.g., LED display, etc.) may display the change in resistance by displaying the first resistance 1902 calculated at the first time 1806 and displaying the second resistance 1904 calculated at the second time 1808. In one implementation the electronic display may change colors to indicate colorant at or below the location of the thermistor probe 1504 (e.g., “blue” for colorant above thermistor probe 1504 or “red” for colorant below thermistor probe 1504). As one example, the color indication may be determined based on the predetermined resistance threshold for the material.

By way of example, a level sensing system 1400 may operate with a fixed “on” time of 500 ms and a fixed “off” time of 100 ms. In this implementation, during the “on” time, the PWM duty cycle may operate at a value of 15/255 at 24V. Further, the value of the current sensing resistor may be 5.5 ohms, and the change in resistance threshold may be set at 5.5 ohms. As shown in FIG. 19, as an example, if the change in resistance between the two readings 1902, 1904 is less than 5.5 ohms, the electronic display may be shown in “blue” to indicate that the colorant is above the thermistor probe 1504. As shown in FIG. 20, for example, if the change in resistance between the two readings 2002, 2004 is greater than 5.5 ohms, then the electronic display may be shown in “red” to indicate that the colorant is below the thermistor probe 1504.

In one implementation, the configuration of the level detection system 1400, circuit 1700, or other components may be modified to achieve desired results. For example, by adjusting PWM power levels and optimizing the duty cycle (i.e., “on” and “off” times), response times to detect immersed to non-immersed transition and to detect non-immersed to immersed transition may be achieved. For example, response times of 5-6 seconds (immersed to non-immersed) and 1-2 seconds (non-immersed to immersed) may be achieved by changing the “on” time from 5 seconds to 500 ms, and changing the “off” time from 1 second to 100 ms.

In one implementation, thermistor curves (e.g., thermistor resistance versus temperature, etc.) may be incorporated into the level system programming to target specific temperature rises compared to output wattage. In this implementation, thermistor curves may provide more accurate generation of signal wattage by incorporating a feedback control loop. In one implementation, the level sensing system programming may also be configured to track feedback and system values to detect changes over time (e.g., failing thermistor 1510, thermistor probe coated 1504 in colorant, etc.). As an example, one or more types or brands of thermistors 1510 may be selected for the level sensing system. Thermistor selection may be based on thermistor curves that may improve performance of the level sensing system. For example, an EPCOS thermistor (part number: B59010D1135B040 with a nominal resistance of 50 ohms at 25 degrees Celsius) may be used.

Level Detection Timing

In any of the above implementations, level detection may be performed before the start of a tinting process to determine that there is a desired (e.g., sufficient for a desired task) volume of colorant in a dispensing canister to perform the tinting process. At least one level sensor (e.g., metallic probe 904, thermistor 1510, etc.) may be engaged at a predetermined location indicating the desired level of colorant for a tinting process (e.g., low level, etc.). For example, this level may be determinative of a volume of colorant for the desired process that is at least equal to or greater than the amount of a dispense volume of colorant for the desired tinting process. By identifying whether the level of colorant is at or above the location of the level sensor, the level sensing system may determine that a desired volume of colorant is present before the start of the paint tinting process. Further, for example, if the level sensing system 100, 300, 1400 determines that an insufficient (e.g., for the desired tinting process) colorant volume is present in the dispensing canister, the system may cancel the paint tinting operation to avoid incorrectly tinted paint, and may alert a user.

Further, in any of the above implementations, level detection may be performed continuously during a tinting process. For example, the sensor (e.g., metallic probe 904, thermistor 1510, etc.) position may be placed at a level corresponding with a known volume to determine that the volume of colorant present is at least greater than known volume, for example, the volume of colorant remaining after a completed tinting process. In one implementation, the level sensing system may calculate the volume of colorant remaining following completion of a paint tinting process by logging the time the colorant reaches the sensor level. In this implementation, the amount of colorant yet to be dispensed (e.g., when the sensor is reached) may be subtracted by the known volume corresponding to the sensor level. As an example, this feature may provide an enhancement over current systems in which colorant level is manually entered into the system (e.g., manually entered by the user, who enters canister a volume into the system when the dispensing canister has been filled).

Level Sensing via Pressure Sensor

Level sensing systems 100 and 1400 offer advantageous detection of a liquid volume at a specific predetermined position in the respective dispenser canisters 102 and 1402, for example, at a designated refill level. In detecting a liquid volume at a specific predetermined position, the dispenser system may, for example, help prevent a user from running the dispenser system dry. In one example, a warning may be output by the dispensing system when the predetermined level is reached. Because, when a dispenser system is run dry, damage to pumps may occur. Such damage may incur cost and/or warranty issues, for example. Prevention of such conditions helps alleviate a user from knowingly or unknowingly putting the system at risk for damage.

In some implementations, a user may wish to have more data regarding the current level of the canister in situations, apart from a designated refill level. Determining the level of the fluid in the canisters in systems 100 and 1400 may result in multiple probes and/or thermistors being placed at different levels of the respective canisters. Such duplication of hardware can increase the respective cost and complexity of the respective systems. A level sensing system that uses an individual sensor to detect the fluid volume level of a canister at multiple points can decrease cost and complexity. A system can be devised for continuous detection of the level of material in a dispensing canister. In one aspect, a pressure sensing system may be used to continuously detect the level of the material in the dispenser, which may offer desired advantages.

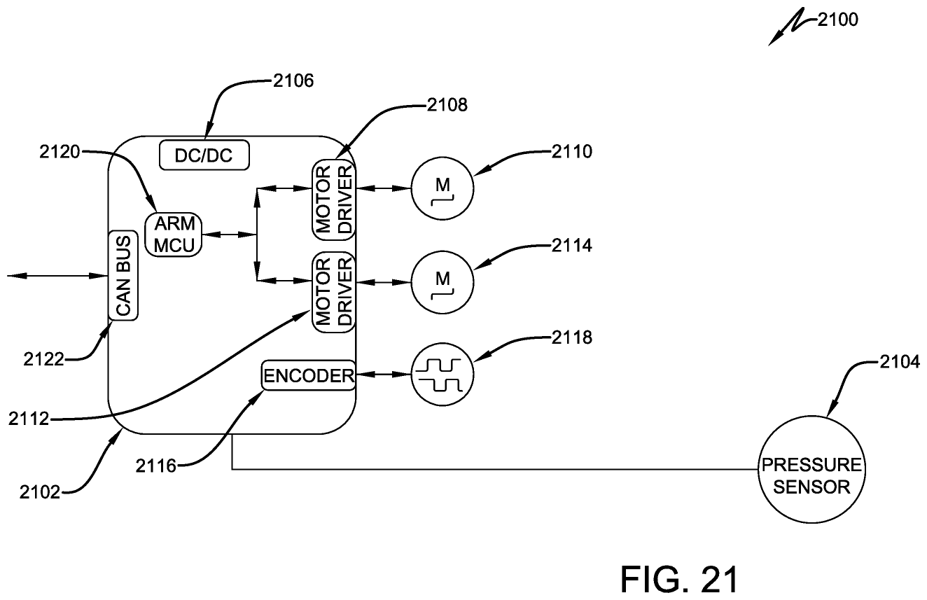

FIGS. 21-23 illustrate one or more portions of an example implementation of one or more systems (e.g., 2100) for continuous level sensing using at least one pressure sensor 2104. FIG. 21 illustrates one implementation of a level sensing system 2100 which may include a motor control board 2102 communicatively (e.g., electrically and/or data communication) coupled with one or more pressure sensors 2104 that are engaged with the dispensing canister 2202. Motor control board 2102 may include (e.g., or be coupled with) a power source 2106, one or more motor drivers 2108 and 2112, an encoder circuit 2116, bus 2122, and a motor control unit (MCU) 2120.

In one implementation, the power source 2106 may be direct current (DC), such as provided by an alternate current (AC) to DC converter, or directly as DC (e.g., battery power, or other); or can be AC provided by a separate poser supply (e.g., utility provided, etc.). The one or more motor drivers 2108 and 2112, coupled with or comprised on the motor control board 2102, may individually interface to respective, corresponding motors. For example, motor driver 2108 (e.g., motor controller) may be electronically coupled with a dispensing motor 2110 engaged with dispensing canister 2202; and motor driver 2112 may be electronically coupled with an agitation motor 2114 of dispensing canister 2202. Encoder circuit 2116 may be engaged with an encoder 2118 of the dispensing motor 2110, for example, to convert a circuit signal to an electrical signal to the motor. The encoder 2118 may be a magnetic encoder, for example. Bus 2122 may communicatively couple the motor control board 2102 with other components, such as processing circuits, of the level sensing system 2100. For example, bus 2122 may connect the motor control board to electronic circuits 500 and/or 1700. Bus 2122 may also connect to control circuit(s), memory, and/or processor(s). In one implementation, the bus 2122 may be a controller area network (CAN) bus, for example. The MCU 2120 may control motor drivers 2108 and 2112 of respective motors 2110 and 2114. The MCU 2120 may be an ARM motor control unit, in an example implementation.

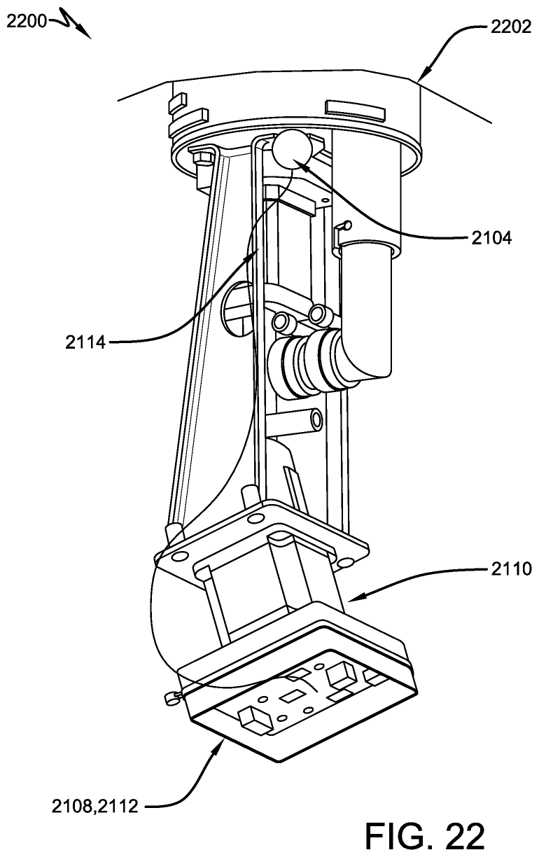

As illustrated in FIG. 22, in a non-limiting implementation 2200, pressure sensor 2104 may be disposed (e.g., mounted) on the bottom of a dispensing canister 2202. Although not shown in FIG. 22, pressure sensor 2104 may alternatively be disposed on a side of dispensing canister 2202. In another embodiment, multiple pressure sensors 2104 may be mounted at common or disparate locations across the dispensing canister 2202. The agitation motor 2114 and/or dispenser motor 2110 may be coupled to dispensing canister 2202. In one implementation, the motors 2114 and 2110 may be stepper motors. The respective electronic motor drivers 2108 and 2112 may be mounted in a common location, for example, as shown in FIG. 22. In another implementation electronic drivers 2108 and 2112 may be mounted in different locations from each other. In one implementation, the example pressure sensor level sensing system 2100 may comprise a control circuit (not shown) having a processor and programming resident in a memory.

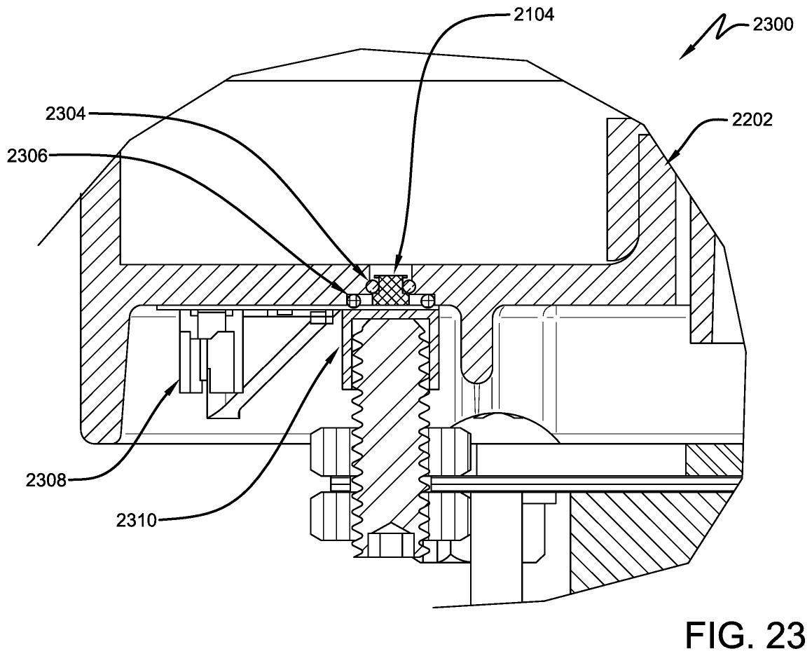

FIG. 23 illustrates a detailed cross-sectional view of an implementation 2300 of an example mechanical coupling between dispensing canister 2202 and pressure sensor 2104. In this implementation, the pressure sensor 2104, for example, may be mounted with a sensing portion disposed within an internal cavity of the dispensing canister 2202. Further, in this implementation, a first O-ring 2304 and a second O-ring 2306 may seal non-sensing portions of the pressure sensor from the internal cavity of the dispenser canister 2202, for example, which can contain fluid contents. The first O-ring 2304 and second O-ring 2306, for example, may comprise varying sizes, sufficient to perform the desired sealing task. In one example, the first O-ring 2304 may comprise a 2 mm internal diameter and the second O-ring 2306 may comprise a 5 mm internal diameter.

In one implementation, a plastic cap 2310 may be utilized to seal non-sensing portions of the pressure sensor 2104 from the internal cavity of the dispenser canister 2202, for example, comprising fluid contents. In an example implementation, a circuit board 2308 may be disposed (e.g., mounted) beneath the dispenser canister 2202. The circuit board 2308 may comprise a motor control board 2102, for example. In one implementation, the circuit board 2308 may comprise circuits 500 and/or 1700. Further, the circuit board 2308 may comprise a control circuit (e.g., a processor) and memory.

In the described implementations, the pressure sensor 2104 comprises a liquid proof pressure sensor that detects pressure at a desired or predetermined location, such as at the bottom of the internal cavity of the dispensing canister 2202. For example, the pressure sensor can comprise a strain gauge type, capacitive type, electromagnetic type, piezoelectric type, strain-gauge type, optical type, potentiometric type, or other types that are appropriate for the described applications. For example, pressure sensor 2104 may be a water proof sensor recently developed and commercially available by STMicroelectronics. The water proof pressure sensor 2104 may be disposed, for example, (e.g., attached) on the bottom of the dispenser canister 2202 and may be used to detect an actual level of the fluid in dispenser canister 2202 in a ‘gas gauge,’ flow meter type of reading.

Alternately, the pressure sensor 2104 may be mounted in a casing, which mitigates exposure to leaked content from the canister, for example, such as using a cap 2310 (e.g., made of plastic, polymer, or other suitable material). In one implementation, a special locking mechanism (not shown) may be utilized with the pressure sensor 2104 and casing assembly to provide for sealing the bottom of the dispenser canister 2202, for example, when the sensor 2104 is removed. The locking mechanism, for example, may be used to mitigate leakage of the fluid in the dispenser canister 2202 during a changing of pressure sensor 2104. As a result, for example, the pressure sensor 2104 as described can be selectably removable and easy to remove (e.g., and perform maintenance or replacement), if needed.

In one implementation, the pressure sensor 2104 may provide data indicative of the sensed pressure (e.g., the data may be transmitted from or pulled from the sensor) to the control board 2102. Alternately, the data indicative of a sensed pressure may be communicated to a separate processing unit (e.g., processor). The data indicative of the sensed pressure, for example, can be used to identify an amount (e.g., volume, level in the canister, weight) of the material in the dispenser canister 2202. For example, as the material is drawn down from the dispenser canister 2202 the pressure indicated at the pressure sensor 2104 may be likewise reduced (e.g., proportionally). In one implementation, the sensed pressure can be compared with known pressure to material amount information to identify an amount of material remaining in the canister. In one implementation, the control board 2102 may be disposed below a dispensing motor (e.g., agitation motor 2114 and dispenser motor 2110).

In some implementations, the material, such as fluid (e.g., colorants), in dispenser canister 2202 may be corrosive. In this implementation, to protect against corrosive fluid, mechanically exposed sensing portions of pressure sensor 2104 may be coated in a waterproof and resistant gel that separates the fluid from the sensing portion of pressure sensor 2104. In some implementations, the fluid contained within a dispenser canister 2202 may comprise water, glycol, or different colorants. In some implementations, the resolution of the data provided by the pressure sensor 2104 may increase in proportion to an increased density of the medium being measured. That is, for example, material with higher density may result in a more accurate reading from the sensor than material with a lower density. In one implementation, the density of the material contained within the dispenser canister (e.g., and respective dispenser canisters in a multi-canister system) may be saved in memory coupled with a control circuit (e.g., processor) of a pressure sensor level sensing system 2100. That is, for example, a known density for a material can be input to the memory and linked to a container holding that material. While density information may not be needed to identify canister material amount information, in one implementation, it can be used for calculating related parameters that may be utilized by a user of the level sensing system.

In some implementations, even at relatively lower resolution for the sensor data, the pressure sensor leveling system 2100 is able to determine at least 12-16 different stable material level positions within dispensing canister 2202. That is, for example, the level of the material in the canister can be determined at least 12 to 16 positions. In some implementations, as the resolution of the sensor data increases, pressure sensor leveling system 2100 is able to determine a continuous range of stable positions within the dispensing canister.

In some implementations, in order to increase accuracy and/or precision of the pressure sensor leveling system 2100, an ambient pressure sensor (not shown) may be utilized with the system, along with the pressure sensor 2104. In this implementation, the ambient pressure sensor may, for example, be an air pressure sensor, barometric pressure sensor, or the like. As an example, the ambient pressure sensor may continuously (e.g., or periodically) measure the atmospheric pressure proximate to the pressure sensing leveling system 2100. In one implementation, utilizing data from the pressure sensor 2104 and the ambient pressure sensor, pressure sensing leveling system 2100 may determine the absolute pressure of the material disposed in the dispensing canister 2202, due to the current volume of fluid within the dispensing canister 2202, and accordingly, the amount of fluid in the canister respective of changes in local external pressure.

In some implementation, the temperature of the fluid within dispensing canister 2202 may have some effect on the accuracy and/or precision of material amount calculation, based on pressure measurements. In one implementation, in order to increase accuracy and/or precision of a level sensing system with a pressure sensor (e.g., system 2100), a temperature sensing component may be utilized with pressure sensor 2104. In an alternative implementation, temperature sensing may be provided by integration of the pressure sensor level sensing system (e.g., system 2100) with a thermistor sensor level sensing system (e.g., system 1400).

As an example, along with an increase in sensitivity and/or precision of the pressure sensor 2104, utilizing the temperature sensing unit with the pressure sensor level sensing system 2100 may add an advantageous feature of measuring a real temperature of the fluid contents (e.g., colorants), which can be used by the user of the system. Further, for example, some solvent-based colorants may comprise a flash point at certain temperatures or pressures. In one implementation, measurement of ambient temperature and/or respective material (e.g., fluid) temperature may be used by the pressure sensor level sensing system 2100 to determine whether the fluid of canister 2202 is nearing its respective flashpoint. For example, known flashpoint temperatures may be stored in memory (not shown) coupled with a control circuit (not shown), which is coupled with or associated with the motor control board 2102 of pressure sensor level sensing system 2100. Thus, for example, the addition of temperature measurement of the fluid may increase safety and alleviate Underwriters Laboratories (UL) specification concerns.

Overall, the implementations described herein have found that the pressure sensor level sensing system (e.g., system 2100) offers the advantage of a relatively easy integration with other electronic sensing systems, while maintaining a high-level of cost-effectiveness, which is a concern in color distribution technologies. Further, the use of pressure sensor level sensing system 2100 can provide for measurement of the actual level of fluid (e.g., colorant) in each dispenser canister 2202 by a sensed pressure in respect to the level of fluid.

In one aspect, an additional advantage of using a sensor to sense pressure may be an increased ease in calibration and tuning, if needed. In one implementation, calibration may comprise using the pressure sensor level sensing system 2100 to take a pressure measurements (e.g., fluid pressure, ambient pressure, and/or ambient temperature, etc.) with the dispenser canister 2202 empty. As an example, the empty canister measurement may be performed by placing an empty dispenser canister into the system and activating the pressure sensor detection (e.g., by pressing a button), which is monitored by a control circuit of pressure sensor level sensing system 2100.

Alternatively, in one implementation, a calibration pressure measurement may be performed automatically by the system when the pressure sensor level sensing system 2100 determines that the canister is empty. For example, the system can use a level sensing system that determines fluid at a designated predetermined level (e.g., systems 100 or 1400). In this implementation, the dispenser canister 2202 can be appropriately filled. A user may then indicate to the pressure sensor level sensing system 2100 that dispenser canister 2202 has been filled full or to some predetermined amount. In one example, the user can activate this function by pressing the same or different button of the pressure sensor level sensing system 2100. Alternatively, the pressure sensor level sensing system 2100 may determine that dispenser canister 2202 is appropriately full by use of a level sensing system that determines fluid at a designated predetermined level (e.g., systems 100 or 1400). In this implementation, the pressure sensor level sensing system 2100 can take a subsequent full canister measurement (e.g., fluid pressure, ambient pressure, fluid temperature, and/or ambient temperature, etc.). In this implementation, the pressure sensor level sensing system 2100 can calibrate the pressure sensor using a comparison between the empty level measurement(s) and full level measurement(s). In one implementation, the user (e.g., or the system automatically) can activate a calibration once the dispenser canister is full. In this implementation, for example, activating the calibration of the sensor once filled can zero out the pressure sensor. Therefore, as the amount of material in the dispenser decreases, the pressure reading will deviate from the calibrated (e.g., zeroed out) reading.

In other aspects, additional advantages of pressure sensor level sensing system 2100 may include the pressure sensor 2014 not being affected by sedimentation effects occurring in the fluid, thus mitigating level calculation errors that affect other types of level sensing systems.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A system for detecting a level of a fluid in a dispensing container, comprising:
a pressure sensor comprising a detection end disposed inside a dispensing canister having a top and a bottom that is configured to dispense a fluid, the pressure sensor operably attached to the canister; and
a processing unit comprising:
a motor control board; and
control circuit comprising a processor and programming resident in memory to determine the level at which the fluid is present.

2. The system of claim 1, wherein the pressure sensor is water-proof.

3. The system of claim 1, wherein the pressure sensor is disposed at the bottom of the canister.

4. The system of claim 1, wherein the pressure sensor is configured to continuously detect pressure inside the dispensing container.

5. The system of claim 1, wherein the level at which the fluid is present comprises about twelve to about sixteen fluid levels.

6. The system of claim 1, wherein the level at which the fluid is present is a continuous number of levels.

7. The system of claim 1, wherein the pressure sensor is selectably removable from the canister.

8. The system of claim 1, wherein pressure sensor comprises data indicative of one or more of fluid volume, fluid level in the canister, and/or fluid weight.

9. The system of claim 1, wherein the at least one pressure sensor comprises a non-sensing portion sealed from the inside of the dispensing canister.

10. The system of claim 1, wherein the canister comprises an empty level measurement and a full level measurement configured for calibration pressure measurement.

11. The system of claim 10, wherein the calibration pressure measurement is the difference between the full level measurement and the empty level measurement.

12. The system of claim 1, further comprising a temperature sensor operably coupled with the canister configured to measure temperature of the fluid.

13. The system of claim 1, further comprising an agitation motor and a dispenser motor operably coupled with the canister.

14. A system for detecting a level of a fluid in a dispensing container, comprising:
a plurality of dispensing canisters, each dispensing canister having a top and a bottom that is configured to dispense a fluid;
at least one pressure sensor operably attached to one of the dispensing canisters and configured to continuously monitor pressure of the fluid, the pressure sensor comprising a detection end disposed inside the dispensing canister and operably attached to the canister; and
a processing unit operably communicating with at least one dispensing canister, comprising:
a motor control board; and
control circuit comprising a processor and programming resident in memory to determine the level at which the fluid is present;
the pressure sensor configured to continuously sense the level at which the fluid is present.

15. The system of claim 14, further comprising a plurality of pressure sensors, one or more pressure sensors being operably attached to each dispensing canister.

16. The system of claim 14, wherein at least one of the canisters comprises an empty level measurement and a full level measurement configured for calibration pressure measurement.

17. The system of claim 16, wherein the calibration pressure measurement is the difference between the full level measurement and the empty level measurement.

18. A system for detecting a level of a fluid in a dispensing container, comprising:
a plurality of dispensing canisters, each dispensing canister having a top and a bottom that is configured to dispense a fluid, each dispensing canister having an agitation motor and a dispenser motor operably coupled with the bottom of the dispensing canister;
a plurality of pressure sensors, each operably attached to one of the dispensing canisters, each pressure sensor comprising a detection end disposed inside the dispensing canister and operably attached to the canister and configured to continuously sense the level of the fluid in the dispensing container; and
a plurality of processing units operably communicating with each dispensing canister, comprising:
a motor control board; and
control circuit comprising a processor and programming resident in memory to determine the level at which the fluid is present;

19. The system of claim 18, each dispensing canister comprising an empty level measurement and a full level measurement configured for calibration pressure measurement.

20. The system of claim 19, the calibration pressure measurement is the difference between the full level measurement and the empty level measurement.
